(19) United States
(12) Patent Application Publication
(10) Pub. No.: US 2026/0031754 A1
(43) Pub. Date: Jan. 29, 2026

(54) METHOD FOR OPERATING AN ELECTRIC DRIVE DEVICE, ELECTRIC DRIVE DEVICE

(71) Applicant: Robert Bosch GmbH, Stuttgart (DE)

(72) Inventors: Johannes Mueller, Schoental (DE); Helmut Wolff, Untergruppenbach (DE); Thomas Grau, Mainhardt (DE)

(21) Appl. No.: 19/237,424

(22) Filed: Jun. 13, 2025

(30) Foreign Application Priority Data
Jun. 25, 2024 (DE) 10 2024 205 919.6

(51) Int. Cl. H02P 29/032; H02P 23/14

(52) U.S. Cl. CPC H02P 29/032; H02P 23/14

(57) ABSTRACT

A method for operating an electric drive device. The drive device includes an electric machine. A current strength of an electric current flowing through a supply line of the machine is ascertained, and a maximum value for a target speed of a rotor shaft of the machine is at least temporarily reduced according to the ascertained current strength and a permissible temperature load of at least one component of the electric machine. An electric drive device is also described having an electric machine. A current detection module ascertains a current strength of an electric current flowing through a supply line of the machine, and a maximum value definition module at least temporarily reduces a maximum value for a target speed of a rotor shaft of the machine according to the ascertained current strength and a permissible temperature load of at least one component of the electric machine.

### FIELD

The present invention relates to a method for operating an electric drive device and to an electric drive device, wherein the drive device comprises an electric machine.

### BACKGROUND INFORMATION

Certain temperature protection measures for electric motors and electric components are described in the related art, which are intended to prevent thermal overload of an electric machine as part of an electric drive device. These can be designed purely using electric components and circuits or using software algorithms and aim to operate components within their specified component boundary conditions and to intervene protectively in the event of overload.

For example, German Patent Application No. DE 10 2010 031 517 A1 describes a method for operating a household appliance with an electric consumer, in particular an electric consumer designed as an electric motor, and controlled by power electronics, comprising the following steps: ascertaining an actual value representing the temperature load of the power electronics, comparing the actual value with a limit value representing the maximum tolerable temperature load of the power electronics, and at least temporarily allowing an overload operation if the actual value is below the limit value. The actual value is ascertained in particular according to a consumer actual current, in particular a phase actual current, of the electric motor. Preferably, when the limit value is reached by the actual value, the actual consumer current is limited, for example by reducing the speed of the electric motor, and heating of the power electronics is restricted.

German Patent Application No. DE 10 2020 209 749 A1 describes a method for operating a return pump of a brake system, wherein the return pump comprises a pump element and a pump motor that is designed to actuate the pump element, wherein the pump motor comprises a rotatably mounted rotor and at least one motor winding, wherein a target speed for the rotor is specified, wherein the motor winding is energized in such a way that the rotor rotates at the target speed for actuating the pump element, wherein a present current value of an electric motor current flowing through the motor winding is ascertained, and wherein the target speed is increased according to the ascertained current value in order to prevent a thermal overload of the pump motor and/or to prevent thermal overload of components for controlling the pump motor.

If the target speed is increased, for example, a faster removal of hydraulic fluid from a fluid reservoir is achieved, so that the pump motor is temporarily operated at idle during the control intervention. As a result, the torque generated by the motor and accordingly the current value of the motor current are reduced, at least temporarily. It is assumed that the thermal load of the pump motor and the components for controlling the pump motor substantially corresponds to the magnitude of the motor current.

### SUMMARY

In a method according to the present invention, a current strength of an electric current flowing through a supply line of the machine is ascertained, and a maximum value for a target speed of a rotor shaft of the machine is at least temporarily reduced according to the ascertained current strength and a permissible temperature load of at least one component of the electric machine. An object of the present invention is to limit the supply line current of the electric machine if this is thermally necessary. According to the present invention, this takes place by a demand-based reduction of the maximum value of the target speed. This maximum value represents an advantageous control variable for the control according to the present invention. In contrast to the above-mentioned conventional drive devices and the corresponding operating methods, in which electric currents are evaluated and speeds are changed, the present invention takes a different approach in order to avoid thermal overload of the electric machine. On the one hand, this concerns the type of current ascertained. While, in the related art, a phase current or a current flowing through a motor winding of the electric machine is ascertained, according to the present invention, the current strength of the current flowing through the supply line of the electric machine is ascertained. This has the advantage that other components of the electric machine in the region of the supply line are also taken into account. On the other hand, the present invention considers a maximum value for the target speed of the rotor shaft, which is at least temporarily reduced for preventing thermal overload. As a result, an advantageous, demand-based reduction of the target speed is carried out. For example, in the related art, a temporary idling operation of the electric machine is to be forced by increasing the target speed. This only works in the use case described there. Due to the present invention, however, it is advantageously ensured that thermal overload is reliably avoided in every operating situation of the drive device by limiting the maximum value for the target speed, and thus also the supply line current, also called on-board network current, i.e., the maximum current strength of the current flowing through the supply line.

According to a preferred further development of the present invention, the current strength is ascertained by means of at least one current sensor, in particular a current sensor arranged in the supply line. For example, a measuring resistor, in particular a shunt, is used as a current sensor in the supply line of the electric machine for directly measuring the electric supply line current. Alternatively, at least two phase currents are measured, in particular in each case by means of such a measuring resistor as a current sensor, and the current strength of the supply line current is ascertained according to this. As a result, in each case it is advantageously ensured that the current strength is ascertained accurately and robustly.

Particularly preferably, according to an example embodiment of the present invention, a limit current strength is specified according to the permissible temperature load, and optionally the maximum value is reduced according to the limit current strength. The limit current strength represents a particularly robust way of representing the permissible temperature load.

According to a preferred further development of the present invention, a difference is ascertained by subtracting a square of the limit current from a square of the current strength, a time integral of the difference is ascertained as a load integral value and compared with a specified load integral limit value, and the maximum value is reduced according to the comparison result. Such an integral analysis creates a particularly accurate model for mapping the dependencies, in which both the ascertained current strength and the permissible thermal load are robustly taken into account. Due to the described procedure, the thermal status is modeled with an advantageously simplified thermal model. The thermal status is determined via the described thermal load integral with the aid of the ascertained current strength of the supply line current. The thermally relevant square of the current strength is integrated over time and reduced by a cooling term. The cooling term is determined by the square of the limit current strength, which represents a current strength that may flow permanently in the supply line, without causing overheating of the drive device or the electric machine, for example a control device of the electric machine.

Particularly preferably, according to an example embodiment of the present invention, a correction factor is specified for the current strength and, if the current strength is less than the limit current, the current strength is multiplied by the correction factor before ascertaining the difference. Due to such a correction factor, the accuracy of the integral analysis is further improved. At a current strength below the limit current strength, which, as described above, can be understood as the cooling current strength, the additional correction factor for further integration is then used in particular to adapt the rate of cooling in relation to the heating to measured or simulated curves. Alternatively, only a difference between current strength and limit current strength is ascertained as the load integral value, and a calculation of power losses with resistances or a resulting temperature is avoided. Alternatively, a detailed thermal model is implemented to calculate a temperature of the drive device.

According to a preferred further development of the present invention, an initial maximum value for the current strength is specified, and the load integral limit value is ascertained according to the specified maximum value for the current strength. As a result, a particularly simple way for iteratively ascertaining the load integral limit value is provided. In this respect, an initial maximum value is determined based on the thermal status described above, which is active even without an existing thermally critical state.

Particularly preferably, according to an example embodiment of the present invention, the maximum value for the current strength is reduced by a specified value if the load integral value reaches the load integral limit value, and the load integral limit value is increased according to the reduced maximum value. As a result, a particularly advantageous and simple way for approaching the permissible thermal load is provided. The maximum value is therefore reduced as needed, especially with a constant step size. According to the then specified maximum value in the sense of a present current limit, a new load integral limit value is defined as the permitted thermal load integral, for example by means of a lookup table. Once the load integral limit is reached, the current limit is reduced accordingly and, for example, according to the lookup table, a larger load integral limit is allowed. In particular, this process is carried out until the current limit reaches a minimum limit.

According to a preferred further development of the present invention, if the maximum value for the current strength reaches a specified lower limit and/or the load integral value becomes zero, the initial maximum value for the current strength is specified again. As a result, a particularly advantageous reset condition is taken into account. In this respect, a decrementation of the maximum value for the current strength is carried out in the sense of a current limit. If limiting has already been carried out, actuation continues with the reduced limit even if a temporary cooling, known from the integral evaluation, is recognized. Only when the device has completely cooled down is the maximum current limit reached again and the current limit is increased to its initial value.

Particularly preferably, according to an example embodiment of the present invention, a reference temperature is specified, a temperature is ascertained, in particular by means of at least one temperature sensor and/or a temperature model, of at least one component of the electric machine, and if the temperature is lower than the reference temperature, the load integral limit value is increased according to a temperature difference between the temperature and the reference temperature. The temperature can be measured directly using sensors or ascertained using models. For example, a temperature of a driver circuit, in particular a B6 bridge, of the electric machine is ascertained. For example, a semiconductor switch of the driver circuit is designed to ascertain the temperature, in particular by means of an integrated temperature sensor. Due to the corresponding consideration of the temperature difference that then becomes possible, the advantage is achieved that the approach to the permissible thermal load is further improved. In this respect, a “derating curve” for a maximum permissible power loss is taken into account, which factors into the subsequent definition of the maximum value. For this purpose, the corresponding temperature information is processed. The allowable thermal load integral is increased for temperatures lower than the reference temperature. In particular, the increase occurs in a linear manner depending on the difference to the reference temperature.

According to a preferred further development of the present invention, the maximum value for the target speed is reduced according to a difference between the maximum value for the current speed and the current speed, their respective squares, a present target speed and/or an, in particular maximum, motor voltage of the electric machine. As a result, in each case a particularly advantageous dependency for defining the maximum value is provided, which takes into account the current strength and permissible thermal load in the best possible way. The maximum value for the target speed is preferably regulated via an I controller. At least one of the aforementioned values, in particular the difference of the squares, is used for calculating the control difference. The output of the controller is then the maximum value for the target speed. This maximum value is preferably used to limit the target speed in a motor controller. The maximum value for the target speed is particularly preferably limited between a maximum and a minimum value, i.e. a specified speed range, as a result of which a minimum performance of the drive device is always guaranteed.

An electric drive device according to an example embodiment of the present invention includes a current detection module that is specially designed to ascertain a current strength of an electric current flowing through a supply line of the machine, and a maximum value definition module that is specially designed to at least temporarily reduce a maximum value for a target speed of a rotor shaft of the machine according to the ascertained current strength and a permissible temperature load of at least one component of the electric machine. The electric drive device as a whole is thus designed to perform the method according to the present invention. As a result, in each case the advantages already mentioned above arise. At least one, in particular a plurality or all, of the modules described above and/or below is/are preferably designed as a standalone hardware module or as a component of one or each of a control device, in particular a computer device. The control device comprises the modules in particular as hardware modules and/or software modules and is thus specially designed to perform the corresponding method steps, in particular within the scope of the method according to the present invention. An object of the present invention is to limit the supply line current of the electric machine if this is thermally necessary. According to the present invention, this takes place by a demand-based reduction of the maximum value of the target speed. This maximum value represents an advantageous control variable for the control according to the present invention. In contrast to the above-mentioned, conventional drive devices and the corresponding operating methods, in which electric currents are evaluated and speeds are changed, the present invention takes a different approach in order to avoid thermal overload of the electric machine. On the one hand, this concerns the type of current ascertained. While, in the related art, a phase current or a current flowing through a motor winding of the electric machine is ascertained, according to the present invention the current strength of the current flowing through the supply line of the electric machine is ascertained. This has the advantage that other components of the electric machine in the region of the supply line are also taken into account. On the other hand, the present invention considers a maximum value for the target speed of the rotor shaft, which is at least temporarily reduced for preventing thermal overload. As a result, an advantageous, demand-based reduction of the target speed is carried out. For example, in the related art, a temporary idling operation of the electric machine is to be forced by increasing the target speed. This only works in the use case described there. Due to the present invention, however, it is advantageously ensured that thermal overload is reliably avoided in every operating situation of the drive device by limiting the maximum value for the target speed, and thus also the supply line current, also called on-board network current, i.e., the maximum current strength of the current flowing through the supply line.

According to a preferred further development of the present invention, at least one current sensor, in particular a current sensor arranged in the supply line and/or assigned to the current detection module, is provided for ascertaining the current strength. For example, a measuring resistor, in particular a shunt, is used as a current sensor in the supply line of the electric machine for directly measuring the electric supply line current. Alternatively, at least two phase currents are measured, in particular in each case by means of such a measuring resistor as a current sensor, and the current strength of the supply line current is ascertained according to this. As a result, in each case it is advantageously ensured that the current strength is ascertained accurately and robustly.

Particularly preferably, according to an example embodiment of the present invention, the maximum value definition module is specially designed to specify a limit current strength according to the permissible temperature load and optionally to reduce the maximum value according to the limit current strength. The limit current strength represents a particularly robust way of representing the permissible temperature load.

According to a preferred further development of the present invention, an evaluation module is provided, which is specially designed to ascertain a difference by subtracting a square of the limit current strength from a square of the current strength, to ascertain a time integral of the difference as a load integral value and to compare it with a specified load integral limit value, and the maximum value definition module is specially designed to reduce the maximum value according to the comparison result. Such an integral analysis creates a particularly accurate model for mapping the dependencies, in which both the ascertained current strength and the permissible thermal load are robustly taken into account. Due to the described procedure, the thermal status is modeled with an advantageously simplified thermal model. The thermal status is determined via the described thermal load integral with the aid of the ascertained current strength of the supply line current. The thermally relevant square of the current strength is integrated over time and reduced by a cooling term. The cooling term is determined by the square of the limit current strength, which represents a current that may flow permanently in the supply line, without causing overheating of the drive device or the electric machine, for example a control device of the electric machine.

Particularly preferably, according to an example embodiment of the present invention, the evaluation module is specially designed to specify a correction factor for the current strength and, if the current strength is less than the limit current strength, to multiply the current by the correction factor before ascertaining the difference. Due to such a correction factor, the accuracy of the integral analysis is further improved. At a current strength below the limit current strength, which, as described above, can be understood as the cooling current strength, the additional correction factor for further integration is then used in particular to adapt the rate of cooling in relation to the heating to measured or simulated curves. Alternatively, only a difference between current strength and limit current strength is ascertained as the load integral value, and a calculation of power losses with resistances or a resulting temperature is avoided. Alternatively, a detailed thermal model is implemented to calculate a temperature of the drive device.

According to a preferred further development of the present invention, the evaluation module is specially designed to specify an initial maximum value for the current strength and to ascertain the load integral limit value according to the specified maximum value for the current strength. As a result, a particularly simple way for iteratively ascertaining the load integral limit value is provided. In this respect, an initial maximum value is determined based on the thermal status described above, which is active even without an existing thermally critical state.

Particularly preferably, according to an example embodiment of the present invention, the evaluation module is specially designed to reduce the maximum value for the current strength by a specified value if the load integral value reaches the load integral limit value and to increase the load integral limit value according to the reduced maximum value. As a result, a particularly advantageous and simple way for approaching the permissible thermal load is provided. The maximum value is therefore reduced as needed, especially with a constant step size. According to the then specified maximum value in the sense of a present current limit, a new load integral limit value is defined as the permitted thermal load integral, for example by means of a lookup table. Once the load integral limit is reached, the current limit is reduced accordingly and, for example, according to the lookup table, a larger load integral limit is allowed. In particular, this process is carried out until the current limit reaches a minimum limit.

According to a preferred further development of the present invention, the evaluation module is specially designed to specify the initial maximum value for the strength current again if the maximum value for the current strength reaches a specified lower limit value and/or the load integral value becomes zero. As a result, a particularly advantageous reset condition is taken into account. In this respect, a decrementation of the maximum value for the current strength is carried out in the sense of a current limit. If limiting has already been carried out, actuation continues with the reduced limit even if a temporary cooling, known from the integral evaluation, is recognized. Only when the device has completely cooled down is the maximum current limit reached again and the current limit is increased to its initial value.

Particularly preferably, according to an example embodiment of the present invention, a temperature detection module is provided, which is specially designed to ascertain a temperature, in particular by means of at least one temperature sensor assigned to the temperature detection module and/or a temperature model, of at least one component of the electric machine, and the evaluation module is specially designed to specify a reference temperature and, if the temperature is lower than the reference temperature, to increase the load integral limit value according to a temperature difference between the temperature and the reference temperature. The temperature can be measured directly using sensors or ascertained using models. For example, a temperature of a driver circuit, in particular a B6 bridge, of the electric machine is ascertained. For example, a semiconductor switch of the driver circuit is designed to ascertain the temperature, in particular by means of an integrated temperature sensor. Due to the corresponding consideration of the temperature difference that then becomes possible, the advantage is achieved that the approach to the permissible thermal load is further improved. In this respect, a “derating curve” for a maximum permissible power loss is taken into account, which factors into the subsequent definition of the maximum value. For this purpose, the corresponding temperature information is processed. The allowable thermal load integral is increased for temperatures lower than the reference temperature. In particular, the increase occurs in a linear manner depending on the difference to the reference temperature.

According to a preferred further development of the present invention, the maximum value definition module is specially designed to reduce the maximum value for the target speed according to a difference between the maximum value for the current strength and the current strength, their respective squares, a present target speed and/or an, in particular maximum, motor voltage of the electric machine. As a result, in each case a particularly advantageous dependency for defining the maximum value is provided, which takes into account the current strength and permissible thermal load in the best possible way. The maximum value for the target speed is preferably regulated via an I controller. At least one of the aforementioned values, in particular the difference of the squares, is used for calculating the control difference. The output of the controller is then the maximum value for the target speed. This maximum value is preferably used to limit the target speed in a motor controller. The maximum value for the target speed is particularly preferably limited between a maximum and a minimum value, i.e. a specified speed range, as a result of which a minimum performance of the drive device is always guaranteed.

Further preferred features and combinations of features result from what was described above and from the rest of the disclosure herein. The present invention is explained in more detail below with reference to the figures.

### BRIEF DESCRIPTION OF THE DRAWINGS

FIG. 1 shows an advantageous electric drive device, according to an example embodiment of the present invention.

FIG. 2 shows a method for operating the drive device, according to an example embodiment of the present invention.

### DETAILED DESCRIPTION OF EXAMPLE EMBODIMENTS

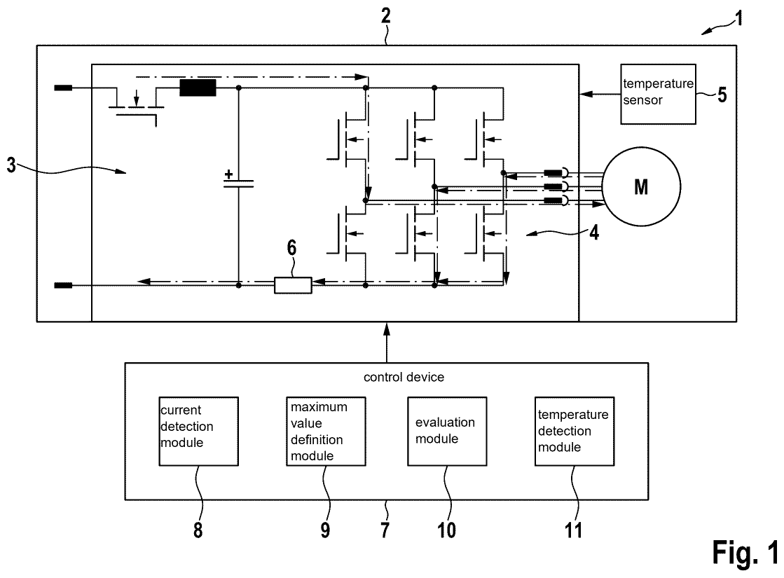

FIG. 1 shows components of an advantageous electric drive device 1. The drive device 1 comprises an electric machine 2, which in the present case is three-phase. The machine 2 comprises a control circuit 3 having a bridge circuit 4, in the present case a B6 bridge, in each case having two semiconductor switches per phase.

The control circuit 3 is assigned at least one temperature sensor 5, which is in particular inserted into the control circuit 3, for example integrated into one of the semiconductor switches. However, temperature sensor 5 is not a necessary component. In addition, the control circuit 3 is assigned a current sensor 6, which in the present case is designed as a measuring resistor (shunt), which in the present case is inserted in a supply line to the bridge circuit 4. Alternatively, current sensors are provided within the respective phase lines.

Finally, the drive device 1 also comprises a control device 7, which is assigned to the electric machine 2, in particular is integrated into the electric machine 2. The control device 7 comprises a plurality of modules in the present case, which, according to alternative exemplary embodiments not shown, can also be designed as separate modules. The modules are preferably connected to each other via communication technology. In the present case, at least one current detection module 8, one maximum value definition module 9, one evaluation module 10 and one temperature detection module 11 are provided.

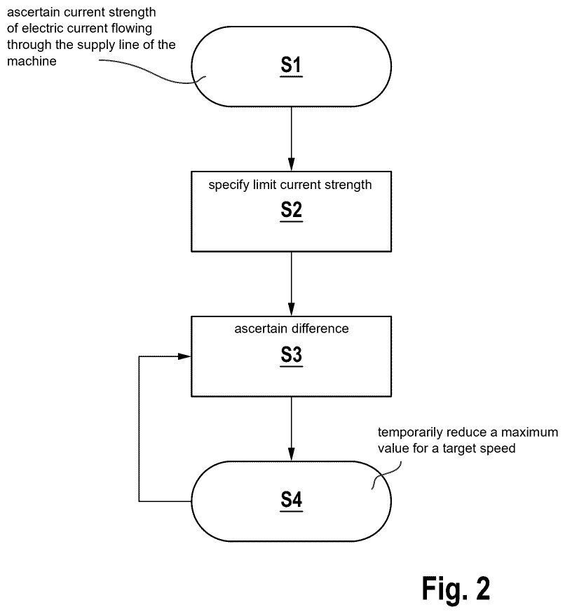

An advantageous method for operating the drive device 1 is described below with reference to FIG. 2. For this purpose, FIG. 2 shows the method using a flow chart. In particular, due to the method, it is ensured that a limitation as needed of a current strength of the supply line current of the electric machine 2 is carried out, so that thermal overload is avoided. The method is performed by means of the control device 7 described above, the corresponding modules 8-11 and in particular the corresponding sensors 5, 6.

In a step S1, the method begins by ascertaining, by means of the current detection module 8, a current strength of an electric current flowing through the supply line of the machine 2. In particular, the current strength is ascertained by means of the current sensor 6 arranged in the supply line. In addition, a temperature of at least one component of the electric machine 2 is ascertained by means of the temperature detection module 11, in particular by means of the temperature sensor 5 and/or a temperature model.

In a step S2, a limit current strength is specified by means of the maximum value definition module 9 according to the permissible temperature load. In addition, an initial maximum value for the current strength is specified by means of the evaluation module 10, and a load integral limit value is ascertained according to the specified maximum value for the current strength. Finally, a reference temperature is specified using the evaluation module 10. Alternatively, the specification of the limit current strength is carried out by the evaluation module 10. In this case, the maximum value definition module is designed to then perform the current control according to the maximum speed or the maximum value of the target speed.

In a step S3, a difference is now ascertained by means of the evaluation module 10 by subtracting a square of the limit current strength from a square of the current strength. Subsequently, a time integral of the difference is ascertained as a load integral value by means of the evaluation module 10 and compared with the specified load integral limit value. Preferably, a correction factor for the current strength is specified by means of the evaluation module 10 and, if the current strength is less than the limit current strength, the current strength is multiplied by the correction factor before ascertaining the difference.

A control is performed by means of the evaluation module 10 and the maximum value definition module 9 in such a way that the maximum value for the current strength is reduced by a specified value if the load integral value reaches the load integral limit value, and the load integral limit value is increased according to the reduced maximum value. If the maximum value for the current strength reaches a specified lower limit and/or the load integral value becomes zero, the initial maximum value for the current strength is specified again by means of the evaluation module 10. If the temperature is lower than the reference temperature, the load integral limit value is increased by means of the evaluation module 10 according to a temperature difference between the temperature and the reference temperature.

In a step S4, as part of the control (steps S3 and S4 are preferably repeated in a loop in this respect), in each case a maximum value for a target speed of a rotor shaft of the machine 2 is at least temporarily reduced by means of the maximum value definition module 9 according to the comparison result, which can change continuously due to the above-described dependency and change in the load integral limit value, and into which the ascertained current and the permissible temperature load characterized by the limit current strength are included.

The maximum value for the target speed is preferably reduced according to a difference between the maximum value for the current strength and the current strength, their respective squares, a present target speed and/or an, in particular maximum, motor voltage of the electric machine 2.

1-20 (canceled)

21. A method for operating an electric drive device, wherein the drive device includes an electric machine, the method comprising the following steps:
ascertaining a current strength of an electric current flowing through a supply line of the machine; and
at least temporarily reducing a maximum value for a target speed of a rotor shaft of the machine according to the ascertained current strength and a permissible temperature load of at least one component of the electric machine.

22. The method according to claim 21, wherein the current strength is ascertained using at least one current sensor arranged in the supply line.

23. The method according to claim 21, wherein a limit current strength is specified according to the permissible temperature load.

24. The method according to claim 23, wherein a difference is ascertained by subtracting a square of the limit current strength from a square of the current strength, a time integral of the difference is ascertained as a load integral value and compared with a specified load integral limit value, and the maximum value is reduced according to a result of the comparison result.

25. The method according to claim 24, wherein a correction factor is specified for the current strength, and when the current strength is less than the limit current strength, the current strength is multiplied by the correction factor before ascertaining the difference.

26. The method according to claim 24, wherein an initial maximum value for the current strength is specified and the load integral limit value is ascertained according to the specified maximum value for the current strength.

27. The method according to claim 26, wherein the maximum value for the current strength is reduced by a specified value when the load integral value reaches the load integral limit value, and the load integral limit value is increased according to the reduced maximum value.

28. The method according to claim 27, wherein when if the maximum value for the current strength reaches a specified lower limit and/or the load integral value becomes zero, the initial maximum value for the current strength is specified again.

29. The method according to claim 24, wherein a reference temperature is specified, a temperature, using at least one temperature sensor and/or a temperature model, of at least one component of the electric machine is ascertained, and when the temperature is lower than the reference temperature, the load integral limit value is increased according to a temperature difference between the temperature and the reference temperature.

30. The method according to claim 21, wherein the maximum value for the target speed is reduced according to: (i) a difference between the maximum value for the current strength and the current strength, and/or (ii) a difference between respective squares of the maximum value for the current strength and the current strength, and/or (iii) a present target speed, and/or (iv) a maximum motor voltage of the electric machine.

31. An electric drive device, having an electric machine, comprising:
a current detection module configured to ascertain a current strength of an electric current flowing through a supply line of the machine; and
a maximum value definition module configured to at least temporarily reduce a maximum value for a target speed of a rotor shaft of the machine according to the ascertained current strength and a permissible temperature load of at least one component of the electric machine.

32. The electric drive device according to claim 31, further comprising at least one current sensor arranged in the supply line and/or assigned to the current detection module, for ascertaining the current strength.

33. The electric drive device according to claim 31, wherein the maximum value definition module is configured to specify a limit current strength according to the permissible temperature load.

34. The electric drive device according to claim 33, further comprising:
an evaluation module configured to ascertain a difference by subtracting a square of the limit current strength from a square of the current strength, to ascertain a time integral of the difference as a load integral value and to compare the time integral with a specified load integral limit value, wherein the maximum value definition module is configured to reduce the maximum value according to a result of the comparison.

35. The electric drive device according to claim 34, wherein the evaluation module is configured to specify a correction factor for the current strength and, when the current strength is less than the limit current strength, to multiply the current strength by the correction factor before ascertaining the difference.

36. The electric drive device according to claim 34, wherein the evaluation module is configured to specify an initial maximum value for the current strength and to ascertain the load integral limit value according to the specified maximum value for the current strength.

37. The electric drive device according to claim 36, wherein the evaluation module is configured to reduce the maximum value for the current strength by a specified value if the load integral value reaches the load integral limit value and to increase the load integral limit value according to the reduced maximum value.

38. The electric drive device according to claim 37, wherein the evaluation module is configured to specify the initial maximum value for the current strength again if the maximum value for the current strength reaches a specified lower limit value and/or the load integral value becomes zero.

39. The electric drive device according to claim 34, further comprising:
a temperature detection module configured to ascertain a temperature, using at least one temperature sensor and/or a temperature model assigned to the temperature detection module, of at least one component of the electric machine, wherein the evaluation module is configured to to specify a reference temperature and, if the temperature is lower than the reference temperature, to increase the load integral limit value according to a temperature difference between the temperature and the reference temperature.

40. The electric drive device according to claim 31, wherein the maximum value definition module is configured to reduce the maximum value for the target speed according to: (i) a difference between the maximum value for the current strength and the current strength, and/or (ii) a difference between respective squares of the maximum value for the current strength and the current strength, and/or (iii) a present target speed, and/or (iv) a maximum motor voltage of the electric machine.
